(19) United States
(12) Patent Application Publication
(10) Pub. No.: US 2018/0164604 A1
(43) Pub. Date: Jun. 14, 2018

(54) ASSEMBLED STRUCTURE OF EYEGLASSES

(71) Applicant: PROHERO GROUP CO., LTD., TAINAN CITY (TW)

(72) Inventor: PEN-WEI CHEN, TAINAN CITY (TW)

(21) Appl. No.: 15/373,808

(22) Filed: Dec. 9, 2016

(51) Int. Cl. G02C 1/08; G02C 5/12; G02C 5/02; G02C 1/04

(52) U.S. Cl. CPC G02C 1/08; G02C 5/12; G02C 2200/08; G02C 1/04; G02C 2200/16; G02C 5/02

(57) ABSTRACT

An assembled structure of eyeglasses is provided. The assembled structure mainly includes a lens having an intercalating detent part disposed on a top edge of the lens to correspond to an intercalating detent slot of an upper frame, an intercalating sunken part disposed in the center of the intercalating detent part to correspond to an intercalation detent bump of the intercalating detent slot, and two inserting detent parts disposed on two sides of the lens to correspond to positioning slots on two inner sides of the upper frame. The bottom edge of the lens can be joined with a lower frame or a nose bridge part. Therefore, the assembling or disassembling of the lens is tool-free, and thus is more convenient and faster to switch between full-rimmed and half-rimmed eyeglasses. The upper and lower frames can have different colors and patterns to increase the trendy and fashion feelings.

### BACKGROUND

### Field of Invention

The disclosure relates to an assembled structure of eyeglasses. More particularly, the disclosure relates to an assembled structure of eyeglasses that assembling or disassembling of the lens thereof is tool-free, and thus is more convenient and faster to switch between full-rimmed and half-rimmed eyeglasses. The upper and lower frames of the eyeglasses can have different types, colors and patterns to increase the trendy and fashion feelings to enhance the competitiveness in the industry and increase the practical utility on the overall implementation.

### Description of Related Art

According to the uses and functions, spectacles can be divided into optical spectacles, sunglasses, sport spectacles, and safety spectacles. The designs for various kinds of spectacles are different. For example, full-rimmed spectacles can completely encapsulate the peripheral of the lenses to provide safer protection to the lenses, and thus is usually used in expensive optical spectacles. Half-rimmed spectacles have a lighter weight than full-rimmed spectacles. Therefore, sunglasses and sport spectacles usually use half-rimmed spectacles to increase the light and convenient feelings of the outdoor activities, sports and constructions.

No matter the eyeglasses are applied in which area, the basic structures all use lenses and a frame assembled together. The lenses are disposed in the lens assembling holes and then locked by screws in the screw hole to stably fix and intercalate the lenses in the lens assembling holes. Temples are disposed on two sides of the frame to complete the assembling of the eyeglasses.

However, although the lenses can be stably intercalated in the lens assembling holes by screwing components, it also needs the screwing tools to tighten or loosen the screwing components. Therefore, it is inconvenient to assemble and disassemble the lenses. In addition, if no proper screwing tools are in hand, the lenses cannot be assembled or disassembled. Hence, the overall structural design still has room for improvement.

Therefore, in view of drawbacks described above, the inventors develop an assembled structure of eyeglasses by the many-year manufacturing and design experience and knowledge in the related fields and ingenuity to provide better practical uses.

### SUMMARY

One main aspect of this invention is to provide an assembled structure of eyeglasses. The assembling or disassembling of the lens is tool-free, and thus is more convenient and faster to switch between full-rimmed and half-rimmed eyeglasses. The upper and lower frames can have different types, colors and patterns to increase the trendy and fashion feelings to enhance the competitiveness in the industry and increase the practical utility on the overall implementation.

According to one embodiment of this invention, the assembled structure of eyeglasses comprises:

an upper frame having an intercalating detent slot disposed on a lower edge of the upper frame, an intercalation detent bump disposed on the center of the intercalating detent slot, two positioning slots disposed on two inner sides of the upper frame, two intercalating sunken parts disposed on two inner sides of the upper frame, and two intercalating connection slots disposed under the intercalating sunken parts;

a lens having an intercalating detent part disposed on a top edge of the lens to correspond to the intercalating detent slot of the upper frame, an intercalating sunken part disposed in the center of the intercalating detent part to correspond to the intercalation detent bump of the intercalating detent slot, and two inserting detent parts disposed on two sides of the lens to correspond to the positioning slots on two inner sides of the upper frame; and

a lower frame having an inserting detent slot disposed to correspond to the bottom edge of the lens, two elastic extending segments disposed on two sides of the lower frame to correspond to the intercalating connection slot of the inner edges on two sides of the upper frame, and two intercalating convex parts disposed protrudingly outward from the upper end of the elastic extending segments to correspond to the intercalating sunken parts on the inner edges on two sides of the upper frame.

According to another embodiment of this invention, the assembled structure of eyeglasses comprises:

an upper frame having an intercalating detent slot disposed on a lower edge of the upper frame, an intercalation detent bump disposed on the center of the intercalating detent slot, two positioning slots disposed on two inner sides of the upper frame, two intercalating sunken parts disposed on two inner sides of the upper frame, and two intercalating connection slots disposed under the intercalating sunken parts;

a lens having an intercalating detent part disposed on a top edge of the lens to correspond to the intercalating detent slot of the upper frame, an intercalating sunken part disposed in the center of the intercalating detent part to correspond to the intercalation detent bump of the intercalating detent slot, two inserting detent parts disposed on two sides of the lens to correspond to the positioning slots on two inner sides of the upper frame, a nose bridge part disposed on the center of the bottom edge of the lens, and an intercalation part disposed on the nose bridge part; and

a nose pad having an intercalating trench disposed on a top edge of the nose pad to be inserted by and joined with the intercalation part of the nose bridge part.

### BRIEF DESCRIPTION OF THE DRAWINGS

FIG. 1 is a front structural exploded view of eyeglasses according to this invention.

FIG. 2 is a local exploded view of this invention.

FIG. 3 is a perspective local exploded view of this invention.

FIG. 4 is a laterally local exploded view of this invention.

FIG. 5 is a front view showing an assembled structure of this invention.

FIG. 6 is a perspective view showing an assembled structure of this invention.

FIG. 7 is a lateral view showing an assembled structure of this invention.

FIG. 8 is a front structural exploded view of eyeglasses according to another embodiment of this invention.

FIG. 9 is a front structural exploded view of eyeglasses according to another embodiment of this invention.

FIG. 10 is a perspective local exploded view of eyeglasses according to another embodiment of this invention.

FIG. 11 is a front structural assembling view of eyeglasses according to another embodiment of this invention.

FIG. 12 is a perspective structural assembling view of eyeglasses according to another embodiment of this invention.

### DETAILED DESCRIPTION

To more completely and clearly illustrate the technical means and effects of this invention, the detailed descriptions are set forth below. Please refer to the disclosed figures and the reference numbers.

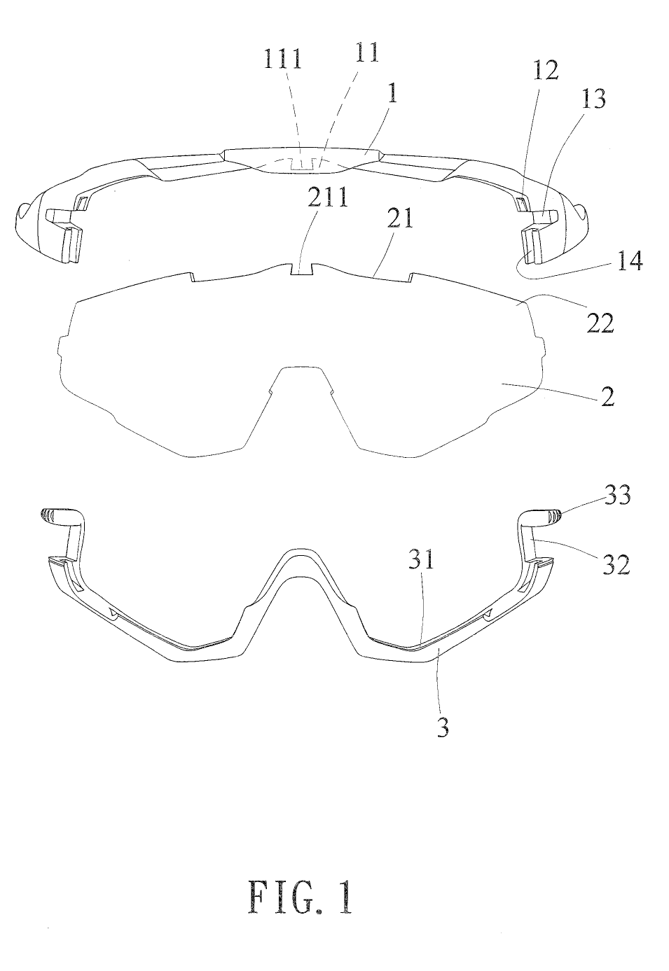

First, please refer to FIG. 1, which is a front structural exploded view of eyeglasses according to this invention. The structure of the eyeglasses comprises an upper frame 1, a lens 2 and a lower frame 3.

On the lower edge of the upper frame 1, an intercalating detent slot 11 is disposed. An intercalation detent bump 111 is disposed on the center of the intercalating detent slot 11. Two positioning slots 12 are disposed on inner edges on two sides of the upper frame 1. Two intercalating sunken parts 13 are also disposed in the inner edges on two sides of the upper frame 1. Two intercalating connection slots 14 are disposed under the intercalating sunken parts 13.

On the top edge of the lens 2, an intercalating detent part 21 is disposed to correspond to the intercalating detent slot 11 of the upper frame 1. An intercalating sunken part 211 is disposed in the center of the intercalating detent part 21 to correspond to the intercalation detent bump 111 of the intercalating detent slot 11. Two inserting detent parts 22 are disposed on two sides of the lens 2 to correspond to the positioning slots 12 on two inner sides of the upper frame 1.

On the upper edge of the lower frame 3, an inserting detent slot 31 is disposed to correspond to the bottom edge of the lens 2. Two elastic extending segments 32 are disposed on two sides of the lower frame 3 to correspond to the intercalating connection slot 14 of the inner edges on two sides of the upper frame 1. Two intercalating convex parts 33 are disposed protrudingly outward from the upper end of the elastic extending segments 32 to correspond to the intercalating sunken parts 13 on the inner edges on two sides of the upper frame 1.

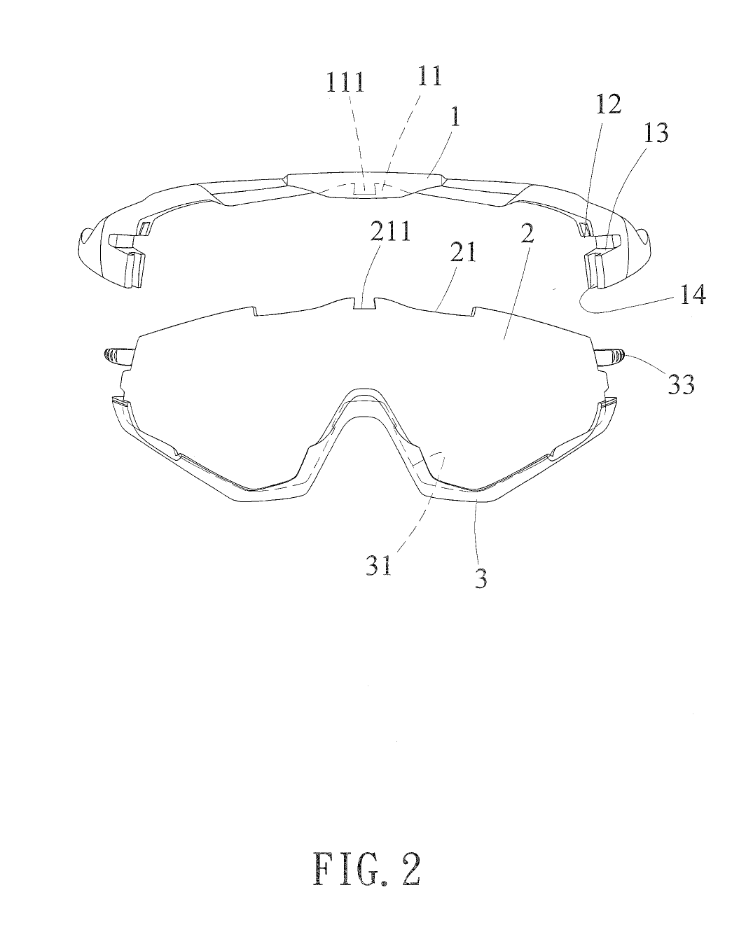

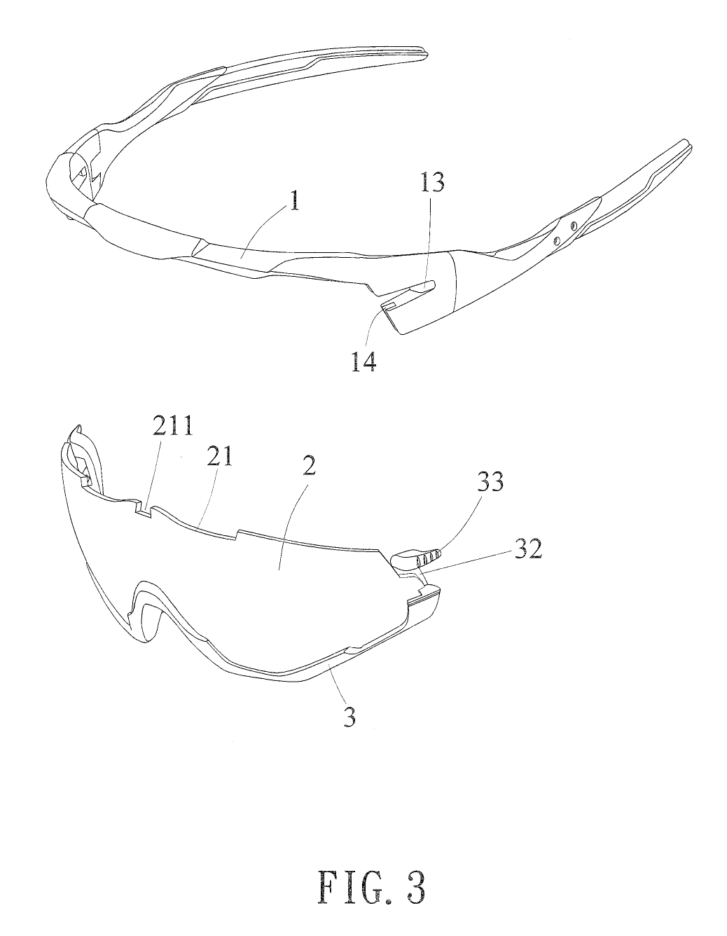

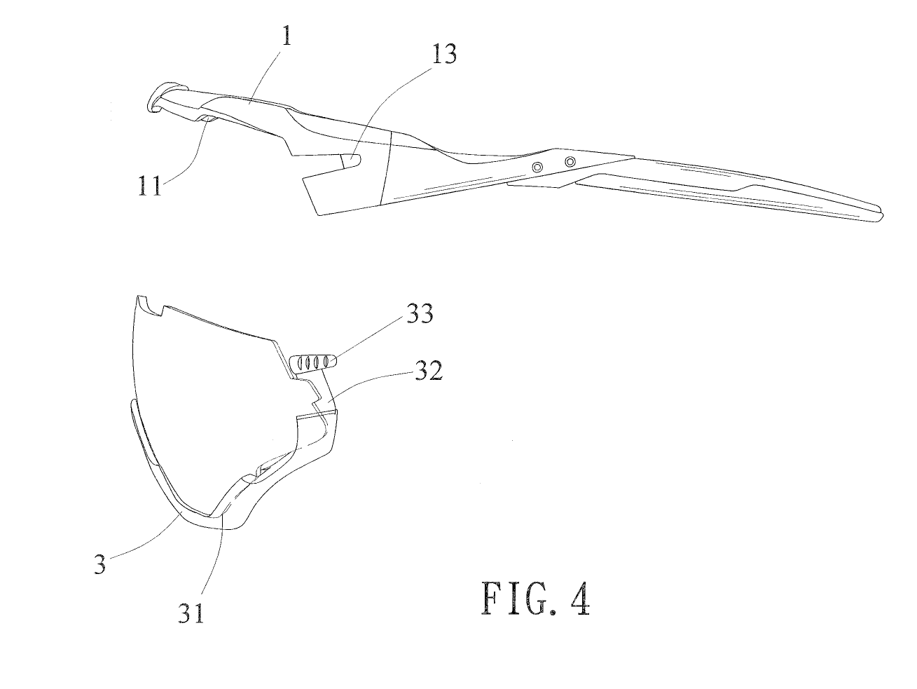

Please also refer to FIGS. 2-4. FIG. 2 is a local exploded view of this invention. FIG. 3 is a perspective local exploded view of this invention. FIG. 4 is a laterally local exploded view of this invention. When the parts above are assembled, the bottom edge of the lens 2 is inserted into the inserting detent slot 31 of the lower frame 3 and thus combined and positioned. The lower frame 3 and the upper frame 1 are assembled to let the intercalating detent part 21 on the top edge of the lens 2 to be assembled in the intercalating detent slot 11 of the upper frame 1. At the same time, the intercalating sunken part 211 on the center of the intercalating sunken part 211 of the lens 2 and the intercalation detent bump 111 of the intercalating detent slot 11 of the upper frame 1 are intercalated and joined each other, and the inserting detent parts 22 on two sides of the lens 2 are intercalated into and joined with the positioning slots 12 on two inner sides of the upper frame 1. At this time, the elastic extending segments 32 on two sides of the lower frame 3 are elastic shrunk to let the intercalating convex parts 33 can be moved along the two inner sides of the upper frame 1. When the intercalating convex parts 33 are moved to the intercalating sunken parts 13 on two sides of the upper frame 1, the intercalating convex parts 33 can be immediately inserted into and joined with the intercalating sunken parts 13. Meanwhile, the elastic extending segments 32 on two sides of the lower frame 3 also can be immediately inserted into and joined with the intercalating connection slots 14 on two sides of the upper frame 1 to assemble and fix the upper frame 1 and the lower frame 3.

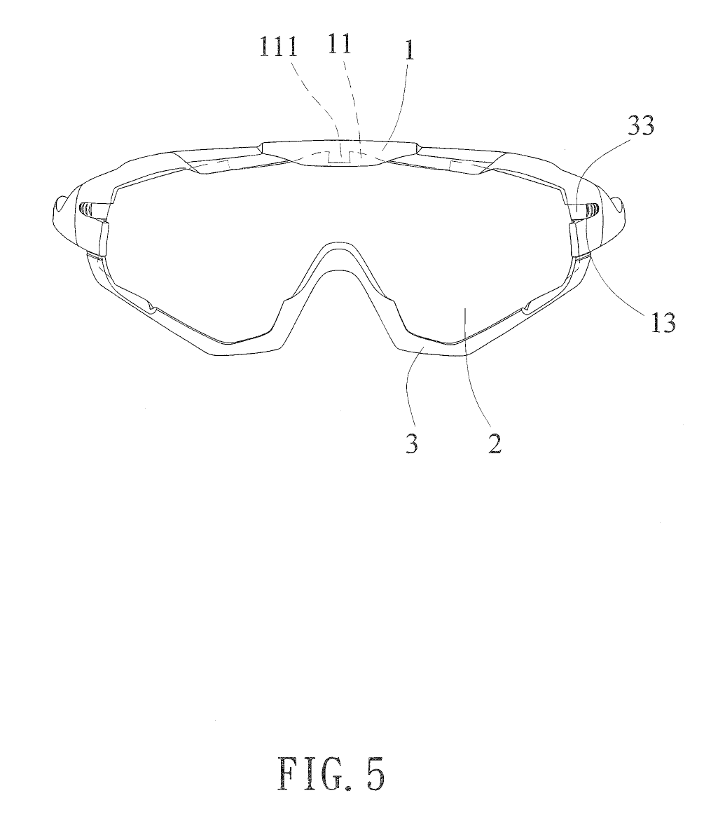

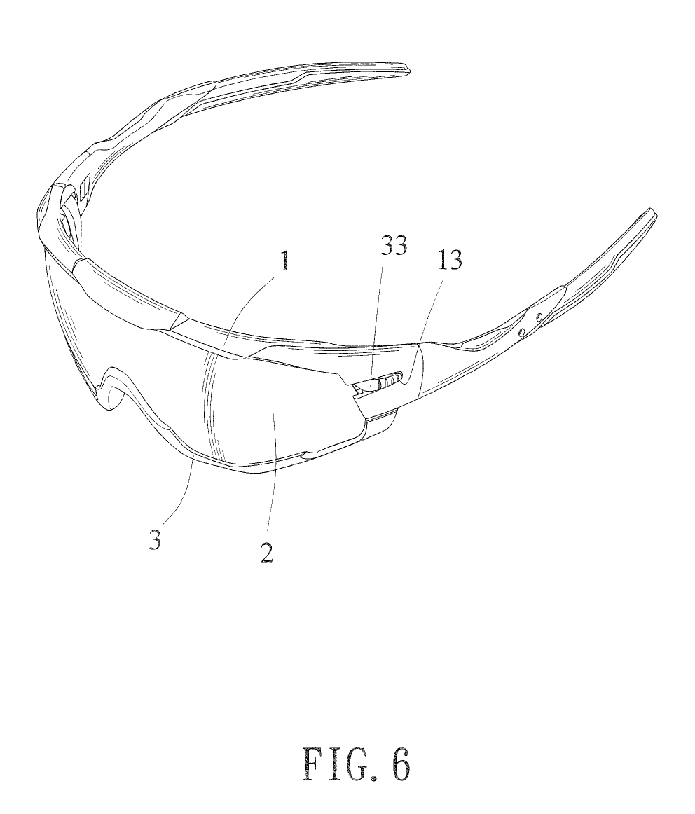

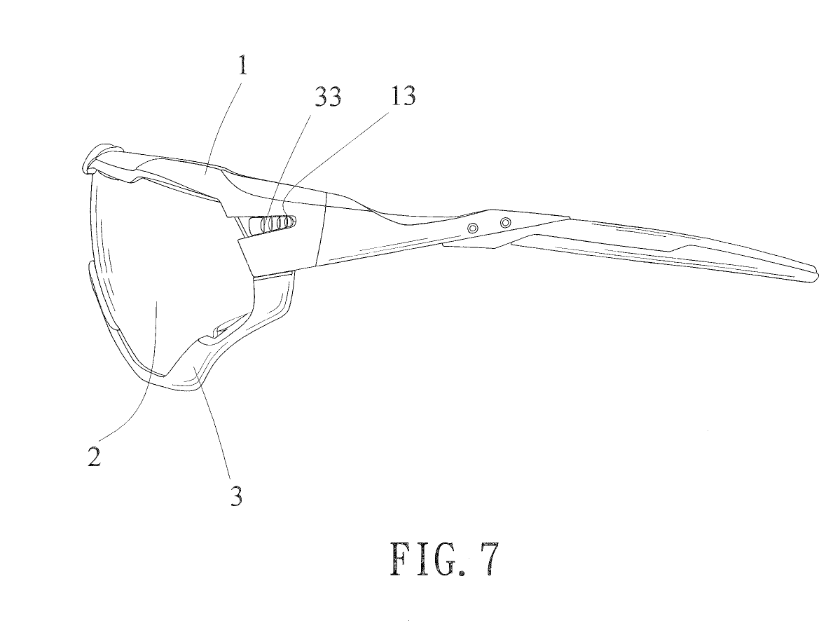

Please also refer to FIGS. 5-7. FIG. 5 is a front view showing an assembled structure of this invention. FIG. 6 is a perspective view showing an assembled structure of this invention. FIG. 7 is a lateral view showing an assembled structure of this invention. When the lens 2 is to be exchanged, the intercalating convex parts 33 on two sides of the lower frame 3 are pushed to move inward, and the elastic extending segments 32 on two sides of the lower frame 3 to be shrunk inward. Therefore, the intercalating convex parts 33 can escape from the intercalating sunken parts 13 on two sides of the upper frame 1 to smoothly remove the lower frame 3 from the upper frame 1, and the lens 2 thus can be taken and exchanged.

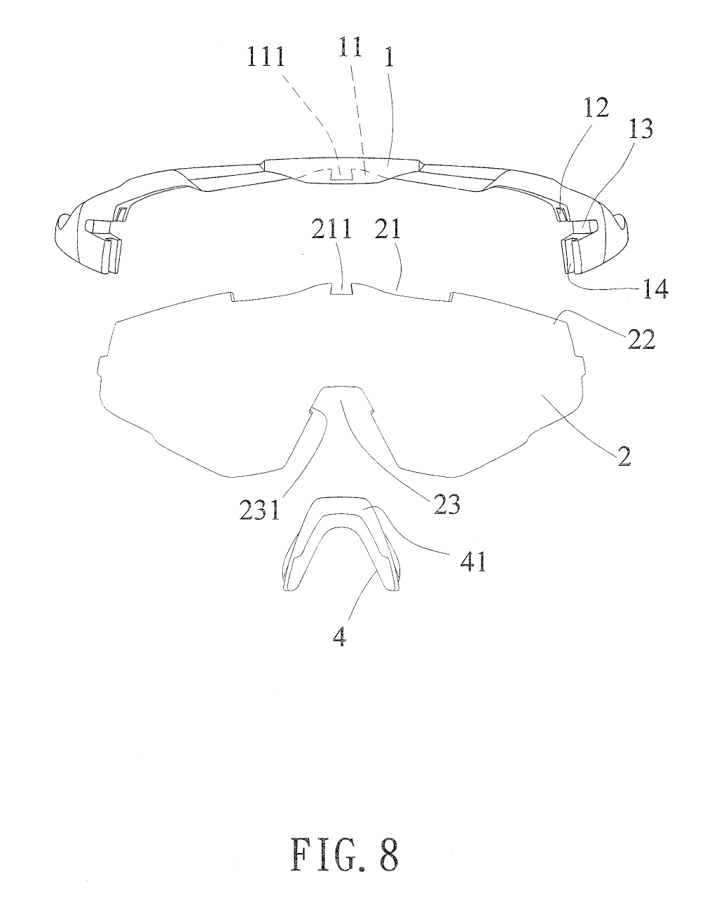

In addition, please also refer to FIG. 8. FIG. 8 is a front structural exploded view of eyeglasses according to another embodiment of this invention. In FIG. 8, a nose bridge part 23 is disposed on the center of the bottom edge of the lens 2, and an intercalation part 231 is disposed to correspond to the nose bridge part 23. Moreover, a nose pad 4 is disposed on the nose bridge part 32. The top edge of the nose pad 4 has an intercalating trench 41 to correspond to the intercalation part 231 of the nose bridge part 23.

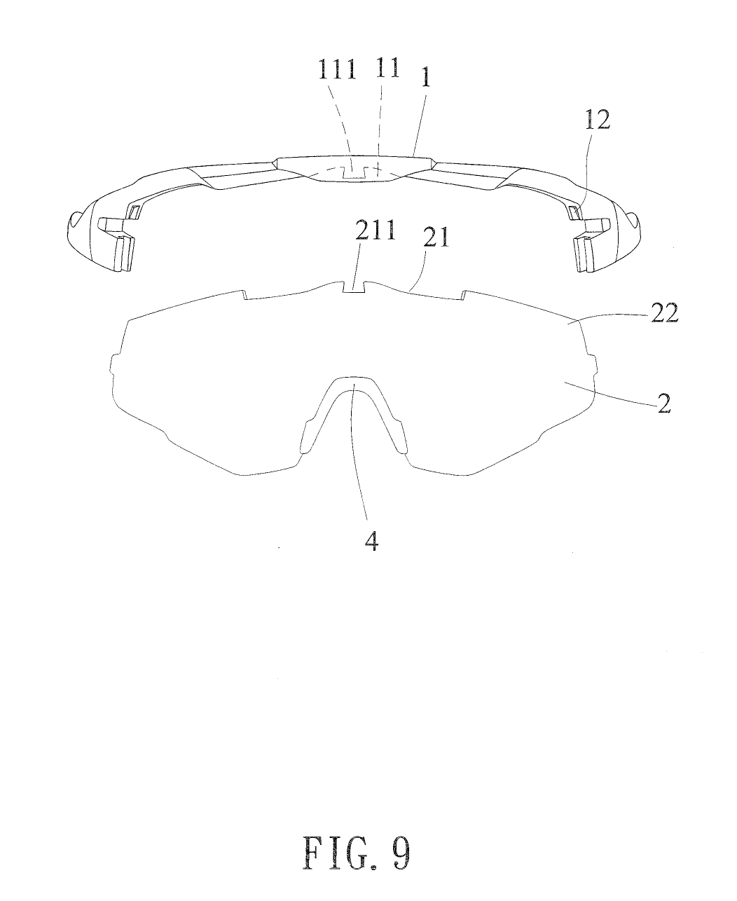

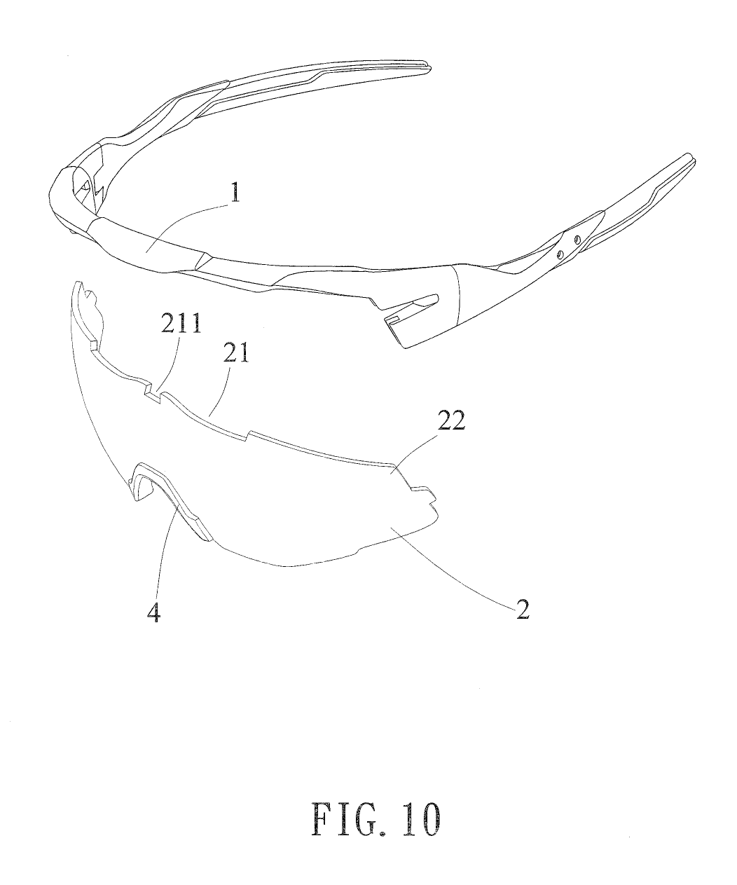

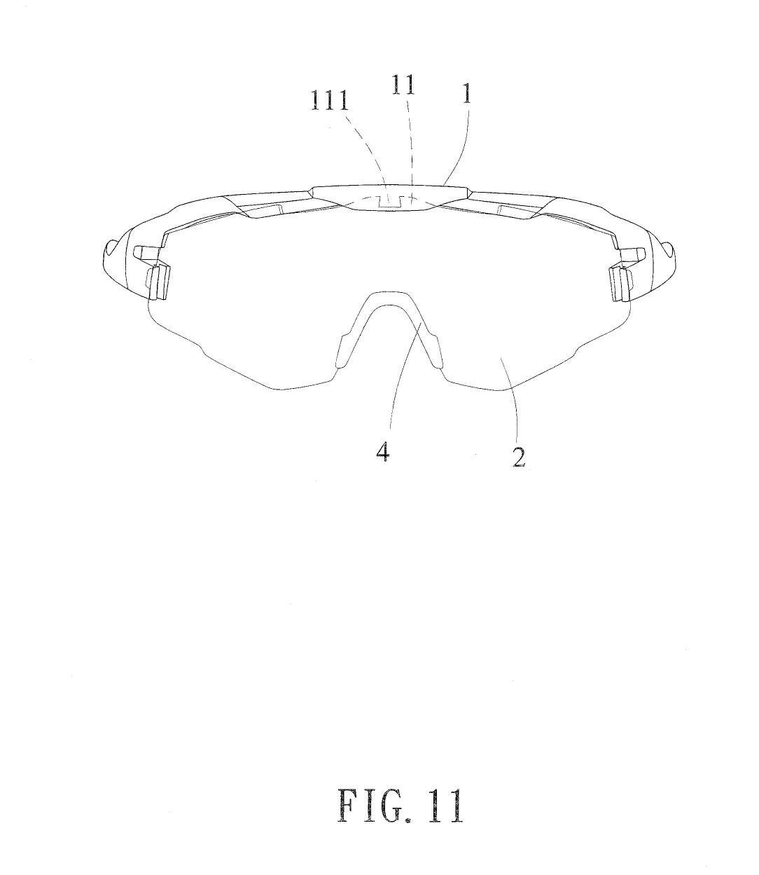

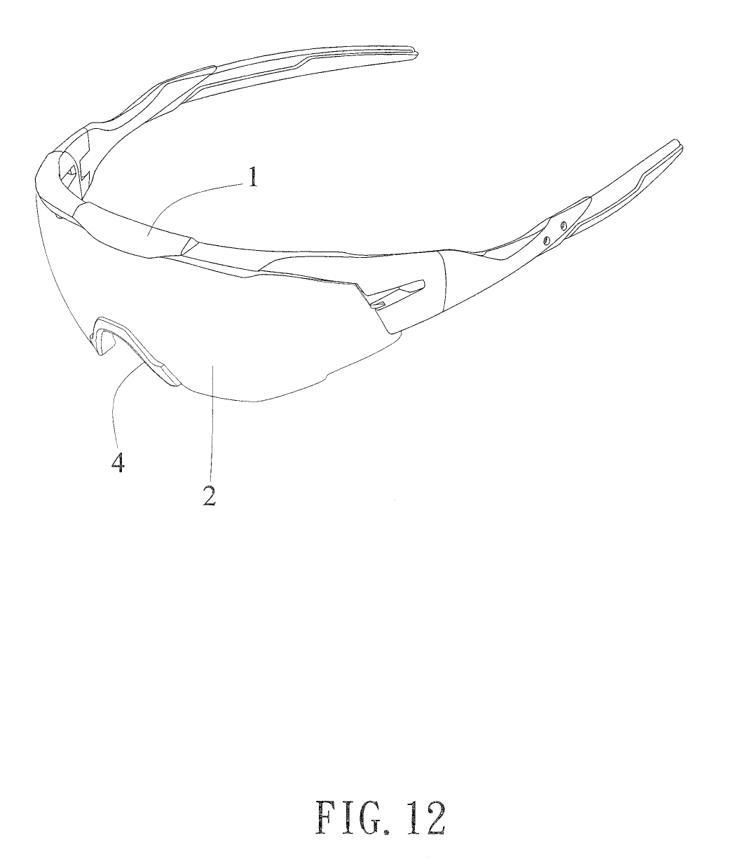

Please refer to FIGS. 9-10. FIG. 9 is a front structural exploded view of eyeglasses according to another embodiment of this invention. FIG. 10 is a perspective local exploded view of eyeglasses according to another embodiment of this invention. When the parts above are assembled, the intercalation part 231 of the nose bridge part 23 on the lens 2 is inserted into the intercalating trench 41 of the nose pad 4 and thus is positioned. Next, the intercalating detent part 21 on top edge of the lens 2 is inserted into the intercalating detent slot 11 of the upper frame 1 and thus is positioned. At the same time, the intercalating sunken part 211 on the center of the intercalating detent part 21 of the lens 2 is inserted by the intercalation detent bump 111 of the intercalating detent slot 11 on the upper frame 1 and combined each other. Meanwhile, the inserting detent parts 22 on two sides of the lens 2 are inserted into the positioning slots 12 on two inner sides of the upper frame 1 to let the upper frame 1 indeed stably combine and position the lens, as shown in FIGS. 11-12. FIG. 11 is a front structural assembling view of eyeglasses according to another embodiment of this invention. FIG. 12 is a perspective structural assembling view of eyeglasses according to another embodiment of this invention.

In light of the foregoing, this invention at least has the following advantages, comparing with the conventional eyeglasses:

1. In this invention, the lens is directly inserted into and thus jointed with the upper frame. Therefore, the assembling or disassembling of the lens is tool-free, and thus is more convenient and faster to increase the practical utility.

2. When this invention is used, the bottom edge of the lens can be assembled with a lower frame or a nose pad to form a full-rimmed glasses or a half-rimmed glasses according to the various needs. Therefore, users don't need to buy different types of full-rimmed or half-rimmed glasses, and users are allowed to significantly reduce the cost of purchasing glasses.

3. Since this invention can be switched between full-rimmed glasses or half-rimmed glasses to have different using types. Moreover, the upper and lower frames can have different colors and patterns to increase the trendy and fashion feelings. Thus, today's innovative new consumer market demand can be lined with to enhance the competitiveness in the industry.

What is claimed is:

1. An assembled structure of eyeglasses, comprising:
an upper frame having an intercalating detent slot disposed on a lower edge of the upper frame, an intercalation detent bump disposed on the center of the intercalating detent slot, two positioning slots disposed on two inner sides of the upper frame, two intercalating sunken parts disposed on two inner sides of the upper frame, and two intercalating connection slots disposed under the intercalating sunken parts;
a lens having an intercalating detent part disposed on a top edge of the lens to correspond to the intercalating detent slot of the upper frame, an intercalating sunken part disposed in the center of the intercalating detent part to correspond to the intercalation detent bump of the intercalating detent slot, and two inserting detent parts disposed on two sides of the lens to correspond to the positioning slots on two inner sides of the upper frame; and
a lower frame having an inserting detent slot disposed to correspond to the bottom edge of the lens, two elastic extending segments disposed on two sides of the lower frame to correspond to the intercalating connection slot of the inner edges on two sides of the upper frame, and two intercalating convex parts disposed protrudingly outward from the upper end of the elastic extending segments to correspond to the intercalating sunken parts on the inner edges on two sides of the upper frame.

2. An assembled structure of eyeglasses, comprising:
an upper frame having an intercalating detent slot disposed on a lower edge of the upper frame, an intercalation detent bump disposed on the center of the intercalating detent slot, two positioning slots disposed on two inner sides of the upper frame, two intercalating sunken parts disposed on two inner sides of the upper frame, and two intercalating connection slots disposed under the intercalating sunken parts;
a lens having an intercalating detent part disposed on a top edge of the lens to correspond to the intercalating detent slot of the upper frame, an intercalating sunken part disposed in the center of the intercalating detent part to correspond to the intercalation detent bump of the intercalating detent slot, two inserting detent parts disposed on two sides of the lens to correspond to the positioning slots on two inner sides of the upper frame, a nose bridge part disposed on the center of the bottom edge of the lens, and an intercalation part disposed on the nose bridge part; and
a nose pad having an intercalating trench disposed on a top edge of the nose pad to be inserted by and joined with the intercalation part of the nose bridge part.
